(19) United States
(12) Patent Application Publication
(10) Pub. No.: US 2014/0149053 A1
(43) Pub. Date: May 29, 2014

(54) TOOLS FOR ENHANCING SURFACE NANOCRYSTALLIZATION AND METHOD FOR MEASURING A NANOCRYSTALLIZATION EFFECT

(71) Applicant: GM Global Technology Operations LLC, Detroit, MI (US)

(72) Inventors: LI SUN, SHANGHAI (CN); JEFF WANG, NANJING (CN); XIAOCHUAN XIONG, SHANGHAI (CN)

(73) Assignee: GM Global Technology Operations LLC, Detroit, MI (US)

(21) Appl. No.: 14/159,835

(22) Filed: Jan. 21, 2014

(30) Foreign Application Priority Data
Nov. 29, 2012 (CN) PCT/CN2012/085510

(51) Int. Cl. C21D 7/08; G01B 21/30

(52) U.S. Cl. CPC C21D 7/08; G01B 21/30
USPC 702/33; 29/90.01

(57) ABSTRACT

A tool for enhancing surface nanocrystallization includes a tool base to removably attach to a machine, a head portion attached to the tool base, and a plurality of blunt pellets. Each blunt pellet i) has a different shape at a respective workpiece-contacting surface to generate a different pressure distribution and depth of indentation during surface nanocrystallization and extends outward from the head portion, or ii) has a same shape at the respective workpiece-contacting surface and extends outward from the head portion.

### CROSS-REFERENCE TO RELATED APPLICATIONS

This application is a continuation-in-part of International Application Serial No. PCT/CN2012/085510, filed Nov. 29, 2012.

### TECHNICAL FIELD

The present disclosure relates generally to tools for enhancing surface nanocrystallization and to a method for measuring a nanocrystallization effect.

### BACKGROUND

Cast iron materials may be used in applications where resistance to surface wear from friction is desirable. Untreated cast iron materials generally tend to corrode when exposed to the environments in which they are used. Some surface treatments, e.g., painting, tend to wear off quickly and/or may be deleterious to proper functioning of the cast iron materials.

### SUMMARY

A tool for enhancing surface nanocrystallization includes a tool base to removably attach to a machine; a head portion attached to the tool base; and a plurality of blunt pellets. Each of the blunt pellets i) has a different shape at a respective workpiece-contacting surface to generate a different pressure distribution and depth of indentation during surface nanocrystallization and extends outward from the head portion, or ii) has a same shape at the respective workpiece-contacting surface and extends outward from the head portion.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a perspective view of a disc brake assembly in an example of the present disclosure;

FIG. 2 is a side view of a drum brake assembly in an example of the present disclosure;

FIG. 3 is a schematic perspective view showing an example of a workpiece and a tool operating thereon;

FIG. 3A is an enlarged cross-sectional schematic view of a portion of the workpiece and tool of FIG. 3, showing the tool forming the nanocrystallized surface layer;

FIG. 4 is an enlarged cross-sectional schematic view showing an example of the workpiece in a nitrocarburizing environment;

FIG. 4A is a schematic depiction of a section view showing an example of a compound layer after ferritic nitrocarburization at a microscopic enlargement;

FIG. 5 is a perspective view of a brake disc in an example of the present disclosure;

FIG. 6 is a scanning electron microscope (SEM) image, similar to the view of FIG. 4, but showing an example of an actual workpiece depicting the microstructure of the substrate and the nanocrystallized surface layer;

FIG. 7 is a perspective view of a brake drum in an example of the present disclosure;

FIG. 8 is a perspective view showing the inside of the brake drum depicted in FIG. 7;

FIG. 9 is a perspective view of a drum-in-hat rotational member;

FIG. 10 is a cross sectional view of the drum-in-hat rotational member depicted in FIG. 9;

FIG. 11A is a flow diagram depicting an example of a method according to the present disclosure;

FIG. 11B is a flow diagram depicting another example of a method according to the present disclosure;

FIG. 12 is a perspective view of a shaft in an example of the present disclosure;

FIG. 13 is a perspective view of an engine block cylinder liner in an example of the present disclosure;

FIG. 14 is a perspective view showing the inside of the brake drum depicted in FIG. 8 with a schematic view of a tool operating thereon;

FIG. 15 is a perspective view of a spherical cap shape blunt pellet according to an example of the present disclosure;

FIG. 16 is a perspective view of a parabolic shape blunt pellet according to an example of the present disclosure;

FIG. 17 is a perspective view of an ellipsoidal shape blunt pellet according to an example of the present disclosure;

FIG. 18 is a perspective view of another ellipsoidal shape blunt pellet according to an example of the present disclosure;

FIG. 19 is a schematic cross-sectional view of a blunt pellet with a coefficient of friction enhancing coating in an example of the present disclosure;

FIG. 20 is a semi schematic side view of a tool in an example of the present disclosure;

FIG. 21 is an end view of the tool depicted in FIG. 20;

FIG. 22 is a perspective view of a tool having a plurality of same shape blunt pellets in an example of the present disclosure;

FIG. 23 is a schematic perspective view showing an example of a workpiece and a tool operating thereon;

FIG. 24A is a schematic profile view depicting an example of a tool with a blunt pellet having a spherical shape operating on a finish surface;

FIG. 24B is a schematic profile view depicting an example of the tool shown in FIG. 24A except having the parabolic shape blunt pellet selected to operate on the finish surface;

FIG. 24C is a schematic profile view depicting an example of the tool shown in FIG. 24B except having the ellipsoidal shape blunt pellet selected to operate on the finish surface; and

FIG. 25 is a schematic depiction of a computer to execute steps of the methods of the present disclosure.

### DETAILED DESCRIPTION

Examples of the present disclosure advantageously provide a tool for enhancing a surface nanocrystallization process for faster or more energy efficient ferritic nitrocarburizing (FNC) treatments of cast iron. A method for measuring a nanocrystallization effect is also disclosed herein.

Generally, examples of the present disclosure include a tool for enhancing surface nanocrystallization by, e.g., deforming the surface against a blunt tool, and accelerated diffusion of nitrogen and carbon atoms through the nanocrystallized surface layer, to form a substantially rust-free and high wear/fatigue resistant case on cast iron components/workpieces.

As used herein, the term “finish surface” refers to the surface of the cast iron workpiece that has been exposed to machining. Also as used herein, the term “nanocrystallized microstructure” refers to the finish surface after it has been exposed to nanocrystallization, i.e., the severe plastic deformation process that is very localized to the surface and near (i.e., up to a depth of a few tens of microns) the surface of the cast iron workpiece. The nanocrystallized microstructure has a refined microstructure which has smaller grains (e.g., from about 5 nm to 2000 nm) than the finish surface (having a grain size >2000 nm)

It is to be understood that in examples of the present disclosure, the deformation against the blunt tool is severe, plastic deformation local to the location of contact between the blunt tool and the workpiece. The deformation occurs substantially without forming chips and without removing material in the process of deformation. Further, the local deformation of examples of the present disclosure is distinct from global deformation that would occur in wire drawing or sheet-metal rolling. Although the deformation of the present disclosure occurs in the vicinity of the blunt tool, a large surface of a workpiece may be nanocrystallized by systematically applying the blunt tool to the entire surface. In an example, a cylindrical surface may be nanocrystallized by rotating the cylinder while moving the blunt tool along the cylindrical axis. In the example, the blunt tool would take a spiral path over the entire surface of the cylinder. It is to be further understood that more than one pass may be made over the finish surface with the blunt tool. In an example, four passes are made over the finish surface with the blunt tool.

It is to be further understood that in examples where a plurality of passes are made over the finish surface each pass may apply a different blunt tool selected from a plurality of blunt tools to the finish surface. In examples, each blunt tool in the plurality of blunt tools may have a different shape at a respective workpiece-contacting surface. The different shape will generate a different pressure distribution and depth of indentation during surface nanocrystallization. In other examples of the present disclosure, each blunt tool in the plurality of blunt tools may have the same shape. The plurality of passes may be made by arranging the plurality of blunt tools on a head portion of a tool to traverse the same path over the finish surface in a predetermined sequence.

Conventional Ferritic NitroCarburizing (FNC) usually takes about 5 to 6 hours at about 570° C. to obtain a 10 micron thick hard layer on the surface of metallic parts (for example, brake rotors) for better wear, fatigue and corrosion resistance. In contrast, examples of the method of the present disclosure may advantageously reduce FNC time down to about 1 to 2 hours to achieve the same hard layer thickness and therefore considerably reduce the processing energy cost.

Referring first to FIG. 11A, an example 100 of the method of the present disclosure includes casting a cast iron (e.g., grey cast iron, nodular cast iron, etc.) workpiece, as shown at reference numeral 102; stress relieving the cast iron workpiece, as shown at reference numeral 104; machining the workpiece to provide a finish surface thereon, as shown at reference numeral 106; deforming the finish surface of the workpiece by rubbing (e.g., by rotating) the finish surface against a blunt tool (described further herein), thereby forming a nanocrystallized surface layer at the finish surface, as shown at reference numeral 108; and nitrocarburizing the workpiece for a period of time ranging from about 1 hour to about 2 hours at a temperature ranging from about 550° C. to about 570° C., as shown at reference numeral 110.

The nanocrystallized surface layer accelerates/facilitates diffusion of nitrogen atoms and carbon atoms therethrough. It is to be understood that the nanocrystallized surface layer (described further below at reference numeral 70) has any suitable thickness. However, in an example of the present disclosure, the thickness of nanocrystallized surface layer 70 ranges from about 3 μm to about 15 μm. In a further example, the thickness of nanocrystallized surface layer 70 is about 8 μm.

Referring now to FIG. 11B, another example 100′ of the method of the present disclosure includes casting a cast iron workpiece, as shown at reference numeral 102; machining the workpiece to provide a finish surface thereon, as shown at reference numeral 106; deforming the finish surface of the workpiece by rubbing (e.g., by rotating) the finish surface against a blunt tool (described further herein), thereby forming a nanocrystallized surface layer at the finish surface, as shown at reference numeral 108; and nitrocarburizing the workpiece for a period of time ranging from about 5 hours to about 10 hours at a temperature ranging from about 370° C. to about 450° C., as shown at reference numeral 110′. The nanocrystallized surface layer accelerates/facilitates diffusion of nitrogen atoms and carbon atoms therethrough.

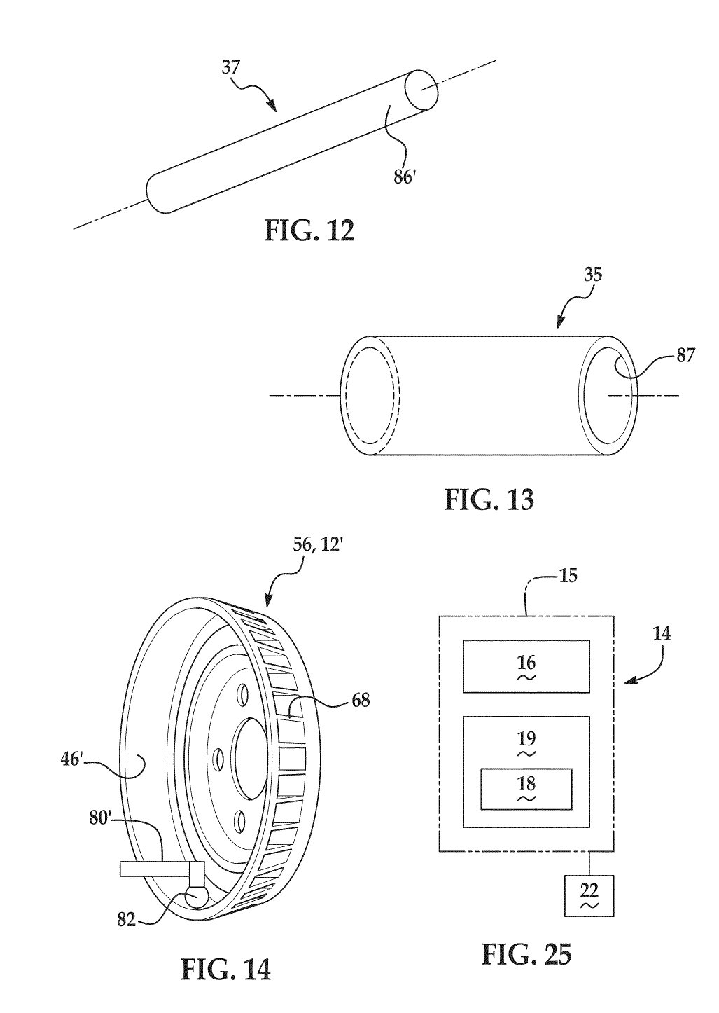

In each of the examples above of the present method, the FNC renders the nanocrystallized surface layer into i) a friction surface (described further below at reference numerals 46, 46′), or ii) a corrosion-resistant surface (e.g., reference numerals 86, 86′ in FIGS. 4A and 12). As used herein, it is to be understood that a “friction” surface may also be a corrosion-resistant surface (in addition to being wear- and fatigue-resistant); however, a “corrosion-resistant” surface is not necessarily a friction surface. It is to be further understood that, in an example, the “corrosion-resistant” surface may be a free (non-contact) surface.

This formation of the nanocrystallized surface layer prior to FNC allows a higher diffusion rate of nitrogen and carbon into the cast iron workpiece, which leads to a considerably more efficient FNC process.

Without being bound to any theory, it is believed that at least the following three aspects are improved with methods of the present disclosure: 1. at conventional FNC temperatures (e.g., method 100), the FNC processing time may be reduced down to about 1 hour to 2 hours (from the conventional 5 to 6 hours); 2. alternatively (e.g., method 100′), FNC may be performed at a low temperature at which conventional FNC cannot thermodynamically create a hard nitride layer. This low temperature treatment may lead to a better dimensional stability, thereby eliminating the need for a stress relief step in some instances; and 3. the surface nanocrystallized microstructure may itself contribute to better wear and fatigue performance of the workpiece.

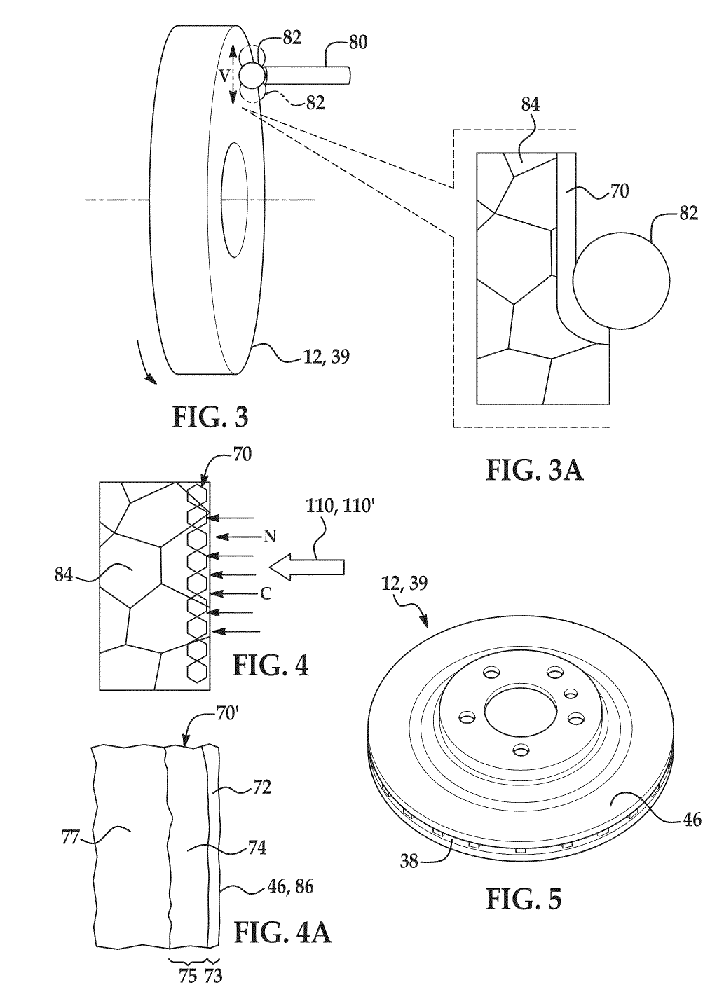

Referring now to FIG. 3, an example of a workpiece (e.g., a rotational member/brake rotor 12, 39) and a hard, blunt tool 80 operating thereon is shown (this takes place after the finish machining of the cast iron workpiece). The workpiece is depicted rotating about an axis while the tool 80 including a blunt pellet 82 (made, e.g., from an iron-tungsten alloy, cast iron, silicon carbide, boron nitride, titanium nitride, diamond, hardened tool steel, tungsten carbide, or the like) in contact with the finish surface. It is to be understood that, according to examples of the present disclosure, the workpiece, the tool 80, 80′ (see FIG. 14), or both may be rotating while the tool 80, 80′ is operating on the workpiece. Still further, in examples of the present disclosure, neither the tool 80, 80′ nor the workpiece may be rotating, but rather the tool 80, 80′ may be moving, e.g., transversely forward and backward while the workpiece is translated longitudinally, or vice versa. It is to be yet further understood that other methods of bringing the tool 80, 80′ into deforming rubbing contact with the workpiece are contemplated as being with the purview of the present disclosure.

The tool 80, 80′ applies a deforming force to the finish surface of the workpiece. In an example, the blunt tool 80, 80′ may be advanced by rotating a leadscrew that controls the advancement of the blunt tool 80, 80′ into a rotating finish surface of the workpiece by about 0.03 mm beyond first contact between the rotating workpiece and the blunt tool 80. It is to be understood that advancing the blunt tool 80, 80′ by about 0.03 mm does not necessarily create penetration of 0.03 mm in part because of elastic deformation of the workpiece, the pellet 82, and the holding fixture of the blunt tool 80. Further, the pellet 82 is not sharp and does not cut the finish surface. Blunt tool 80 reorganizes the crystal structure of the finish surface substantially without removing material therefrom. It is to be understood that the deformation of the finish surface may not be visible to the naked eye. However, a change in the reflective properties of the finish surface may be observable to the naked eye.

In an example, the tool 80 may cause pellet 82 to vibrate relative to the workpiece (as indicated by the double sided arrow V shown in phantom in FIG. 3). The vibration may be accomplished at ultrasonic frequencies (e.g., about 10,000 Hz to about 100,000 Hz).

FIG. 3A is an enlarged schematic view showing the pellet 82 of the tool 80 forming a nanocrystallized surface layer 70 at the surface of the workpiece substrate 84. It is to be understood that the pellet 82 may be a sphere, a spherical cap, a roller, a parabolic shape, an ellipsoidal shape or any shape that makes a local indentation on the finish surface and creates heavy deformation when operating on the workpiece (e.g., by rotating the workpiece thereagainst). As used herein, a parabolic shape means a paraboloid of revolution. Similarly, an ellipsoidal shape means a portion of an oblate spheroid or prolate spheroid.

In examples of the present disclosure, a coolant may be applied to the tool and/or the workpiece. It is to be understood that the heat transfer properties of the coolant may improve tool life and nanocrystallization characteristics, however, lubrication may have deleterious effects on the method disclosed herein in some instances. Examples of suitable coolants are water, air, carbon dioxide gas, and nitrogen gas which generally do not have high lubricity but have good heat transfer characteristics.

FIG. 4 is an enlarged cross-sectional schematic view showing an example of the workpiece in a nitrocarburizing environment. The nanocrystallized surface layer 70, due, e.g., to a large number of grain boundaries, facilitates diffusion of the nitrogen and carbon therethrough, toward the base material substrate 84 during the FNC process(es) 110, 110′.

Examples of the methods of the present disclosure are relatively simple to execute and can be applied to many workpieces (one example of which is a component with axial symmetry that can be rotated during metal work, e.g., components having a disc shape or round bar shape). FIG. 12 depicts a cast iron shaft produced according to an example of the present disclosure. The cast-iron shaft 37 has a corrosion-resistant surface 86′ formed according to an example of the present disclosure. FIG. 13 depicts a cast iron engine block cylinder liner produced according to an example of the present disclosure. The cast iron engine block cylinder liner 35 has an internal surface 87 (formed according to an example of the present disclosure) that resists wear from friction by piston rings and resists corrosion.

An example of a cast iron workpiece is a rotational member of a vehicle brake. A brake 10 is an energy conversion system used to retard, stop, or hold a vehicle. While a vehicle in general may include spacecraft, aircraft, and ground vehicles, in this disclosure, a brake 10 is used to retard, stop, or hold a wheeled vehicle with respect to the ground. More specifically, as disclosed herein, a brake 10 is configured to retard, stop, or hold at least one wheel of a wheeled vehicle. The ground may be improved by paving.

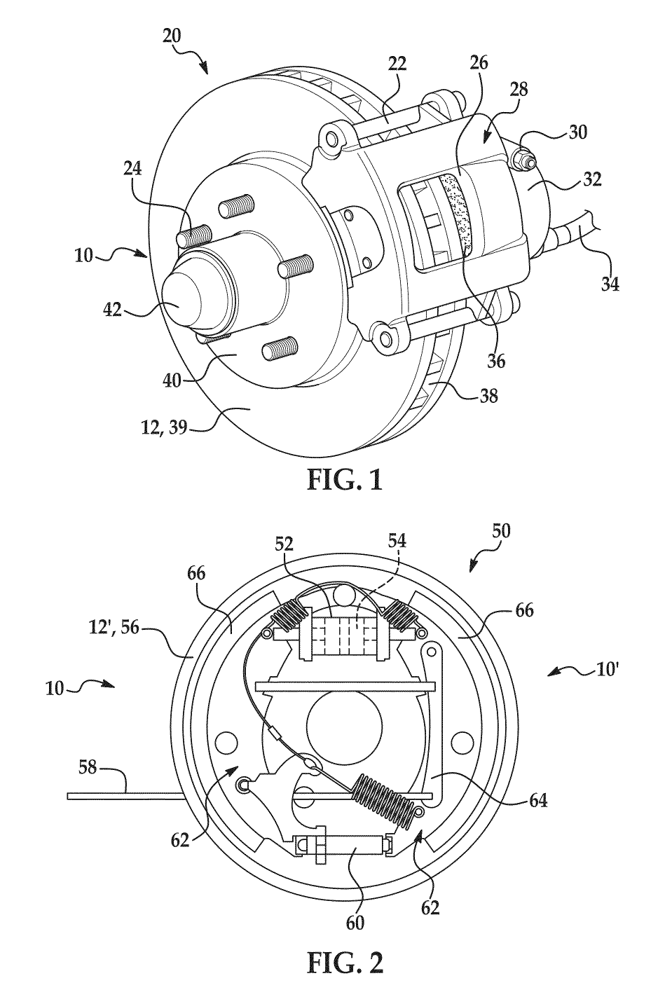

A vehicle brake 10 may be a disc brake 20, drum brake 50, and combinations thereof. FIG. 1 depicts an example of a vehicle brake, in particular, a disc brake 20. In a disc brake 20, a rotational member 12 is typically removably attached to a wheel (not shown) at a wheel hub 40 by a plurality of wheel studs 24 cooperatively engaged with lug nuts (not shown). The rotational member 12 in a disc brake 20 may be known as a brake disc (or rotor) 39. The rotor 39 may include vent slots 38 to improve cooling and increase the stiffness of the brake disc 39. When hydraulic fluid is pressurized in a brake hose 34, a piston (not shown) inside a piston housing 32 of a caliper 28, causes the caliper 28 to squeeze the brake disc 39 between brake pads 36, thereby engaging the disc brake 20. The brake pads 36 may include a friction material that contacts a friction surface 46 of the brake disc 39 when the disc brake 20 is engaged. If the wheel is rotating at the time the disc brake 20 is engaged, kinetic energy of the moving vehicle is converted to heat by friction between the brake pads 36 and the brake disc 39. Some of the heat energy may temporarily raise the temperature of the brake disc 39, but over time, the heat is dissipated to the atmosphere surrounding the vehicle.

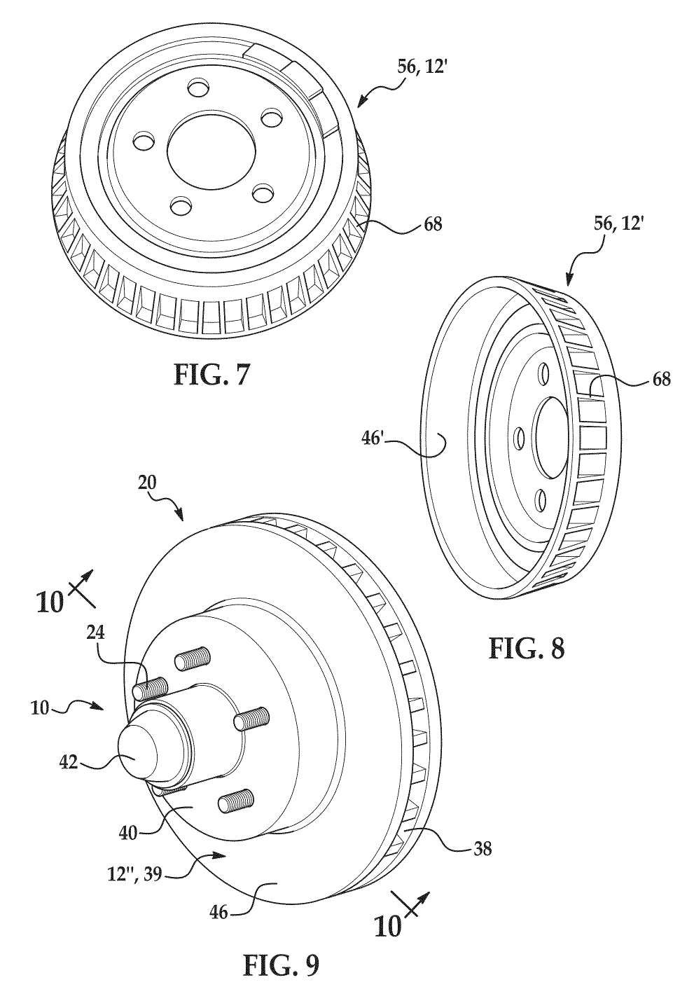

Referring now to FIG. 2, an example of a drum brake 50 is shown. The rotational member 12′ is a brake drum 56 (see also FIGS. 7 and 8). The brake drum 56 is removably fastened to a wheel (not shown). The brake drum 56 may include fins 68 to improve cooling and increase the stiffness of the brake drum 56. When hydraulic fluid is pressurized in a wheel cylinder 52, a piston 54 causes the brake shoes 62 to press a brake lining 66 against the brake drum 56, thereby engaging the drum brake 50. It is to be understood that the brake lining 66 is a friction material. Alternatively, a drum brake 50 may be engaged mechanically by actuating an emergency brake lever 64 via an emergency brake cable 58. The emergency brake lever 64 causes the shoes 62 to press the brake lining 66 against the brake drum 56. If the wheel is rotating at the time the drum brake 50 is engaged, kinetic energy of the moving vehicle is converted to heat by friction between the brake lining 66 and the brake drum 56. Some of the heat energy may temporarily raise the temperature of the brake drum 56, but over time, the heat is dissipated to the atmosphere surrounding the vehicle.

FIG. 7 shows a perspective view of a brake drum 56 in an example of a rotational member 12′. FIG. 8 is a rotated perspective view of the brake drum 56 shown in FIG. 7, showing an inside view of the brake drum 56. The friction surface 46′ is visible in FIG. 8. In examples of the present disclosure, the workpiece may be nanocrystallized in a process similar to the process disclosed herein with respect to FIG. 3 and FIG. 3A. As shown in FIG. 14, an example of the blunt tool 80′ may have a right angle configuration to provide access to the friction surface 46′ on an internal wall of the brake drum 56. When the friction surface 46′ is cylindrical as in the brake drum example depicted in FIGS. 7 and 8, the blunt tool 80′ (see FIG. 14) is advanced into the finish surface by moving the blunt tool 80′radially outward and engaging the pellet 82 with the finish surface and transforming the finish surface into the nanocrystallized surface layer 70 (not shown in FIG. 14) and then into friction surface 46′ after ferritic nitrocarburization (FNC). As shown in both FIGS. 7 and 8, examples of a brake drum 56 may include fins 68.

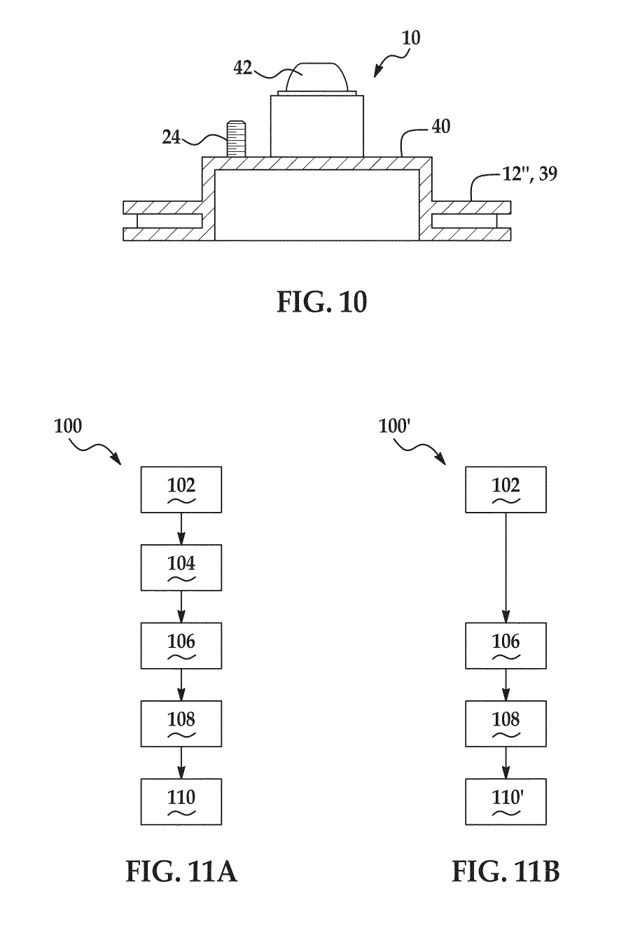

It is to be understood that a disc brake 20 may be combined with a drum brake 50. As shown in FIGS. 9 and 10, a drum-in-hat rotational member 12″ may be included in such a combination. In a drum-in-hat type brake, small brakeshoes may be mechanically/cable actuated as an emergency brake, while the flange portion acts as a typical disc brake.

The rotational member 12, 12′, 12″ includes a friction surface 46, 46′ that is engaged by a friction material of the brake pad 36 or the brake shoe 62. As a brake is engaged to retard a vehicle, mechanical wear and heat may cause small amounts of both the friction material and the rotational member 12, 12′, 12″ to wear away. It may be possible to reduce the rate of wear of the rotational member 12, 12′, 12″ or the friction material by reducing the coefficient of friction between the two, but a lower coefficient of friction may make the brake 10 less effective at retarding the vehicle.

In cast iron, corrosion is mainly the formation of iron oxides. Iron oxides are porous, fragile and easy to scale off. Further, corrosion on a friction surface may be non-uniform, thereby deleteriously affecting the brake performance and useful life. Thus, corrosion may lead to undesirably rapid wear of the friction surface 46, 46′ and the corresponding friction material.

Ferritic nitrocarburization produces a friction surface 46, 46′ that resists corrosion and wear. In examples of the present disclosure, ferritic nitrocarburization is used to render the nanocrystallized surface layer 70 into a compound layer 70′ on the rotational member 12, 12′, 12″ of the workpiece (e.g., brake 10). In an example, rotational member 12, 12′, 12″ has a compound layer 70′ disposed at the friction surface 46, 46′, corrosion-resistant surface 86, 86′. The compound layer 70′ may have an exposed surface in contact with an atmosphere, for example, air.

As depicted in FIG. 4A, compound layer 70′ further may include an oxide layer 72 having Fe₃O₄ disposed at the exposed surface (friction surface 46, corrosion-resistant surface 86). In a number of variations the compound layer 70′ may have a thickness ranging from 5 to 30 microns. An iron nitride layer 74 may include epsilon Fe₃N iron nitride and gamma prime Fe₄N iron nitride may be generally subjacent the oxide layer 72 and containing a majority of epsilon Fe₃N iron nitride. Further, the oxide layer 72 may have a thickness 73 ranging from about 5% to about 50% of a thickness 75 of the compound layer 70′. As shown in FIG. 4A, a diffusion layer 77 is subjacent the iron nitride layer 74 and is a transition between the iron nitride layer 74 and a portion of the workpiece (e.g., rotational member) that is beyond the reach of ferritic nitrocarburization (not shown). Non-limiting variations of salt bath ferritic nitrocarburization processes can be found in U.S. Patent App. Pub. No.: 2013/0000787A1.

In an example, a ferritically nitrocarburized rotational member 12, 12′, 12″ having a friction surface 46, 46′ formed by methods of the present disclosure exhibits a friction material wear of less than 0.4 mm per 1000 stops at about 350° C. An experiment using the test procedure in Surface Vehicle Recommended Practice J2707, Issued February 2005 by SAE International may be conducted. An Akebono NS265 Non Asbestos Organic (NAO) friction material may be used in the experiment.

Referring now to FIG. 5, a perspective view of a brake disc 39 in an example is shown. Rotational member 12 is a brake disc 39 with vent slots 38.

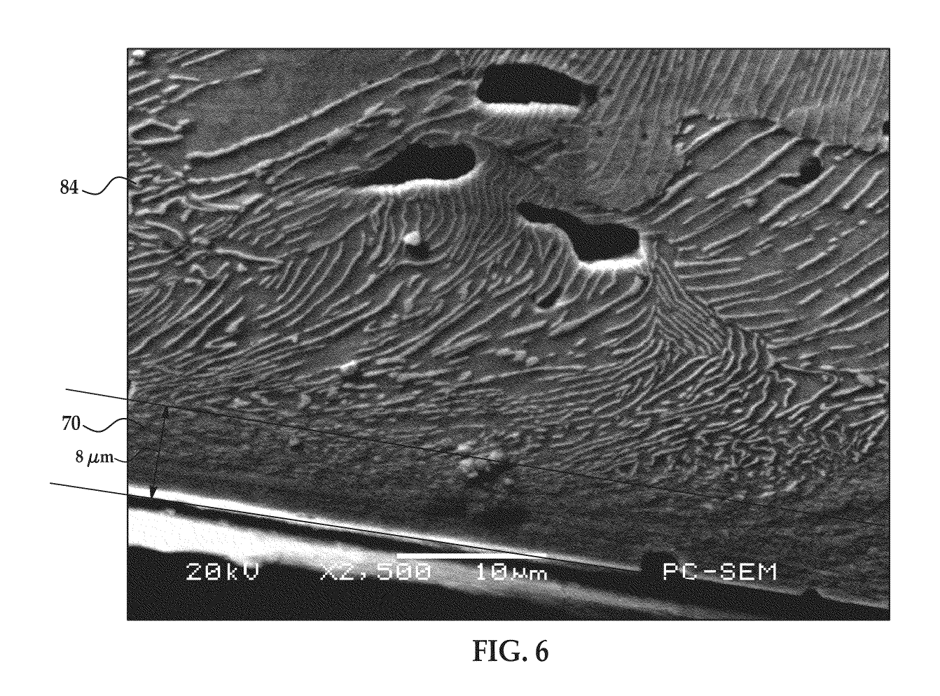

FIG. 6 is a scanning electron microscope (SEM) image showing an example of an actual workpiece depicting the microstructure of the workpiece substrate and the nanocrystallized surface layer (the thickness of the nanocrystallized surface layer 70 in this example is about 8 microns). A scale indicator is provided in FIG. 6 to facilitate estimation of relative sizes.

The workpiece/rotational member 12, 12′, 12″ may be made from cast iron. The friction surface 46, 46′ may exhibit a hardness of between about 56 HRC and about 64 HRC. Hardness is directly related to wear resistance.

Machining 106 may be accomplished by, for example, turning, milling, sand blasting, grit blasting, grinding, and combinations thereof.

It is to be understood that nitrocarburizing includes a gas nitrocarburizing process, a plasma nitrocarburizing process, or a salt bath nitrocarburizing process. The salt bath nitrocarburizing process may include immersing at least the friction surface 46, 46′ of the rotational member 12, 12′, 12″ into a nitrocarburizing salt bath, and then immersing at least the friction surface 46, 46′ of the rotational member 12, 12′, 12″ into an oxidizing salt bath.

It is to be understood that the rotational member 12, 12′, 12″ may include a brake disc 39, a brake drum 56, or a combination thereof.

Further, examples of the present methods 100, 100′ may improve corrosion resistance similarly to FNC methods performed without first forming the nanocrystallized surface layer 70.

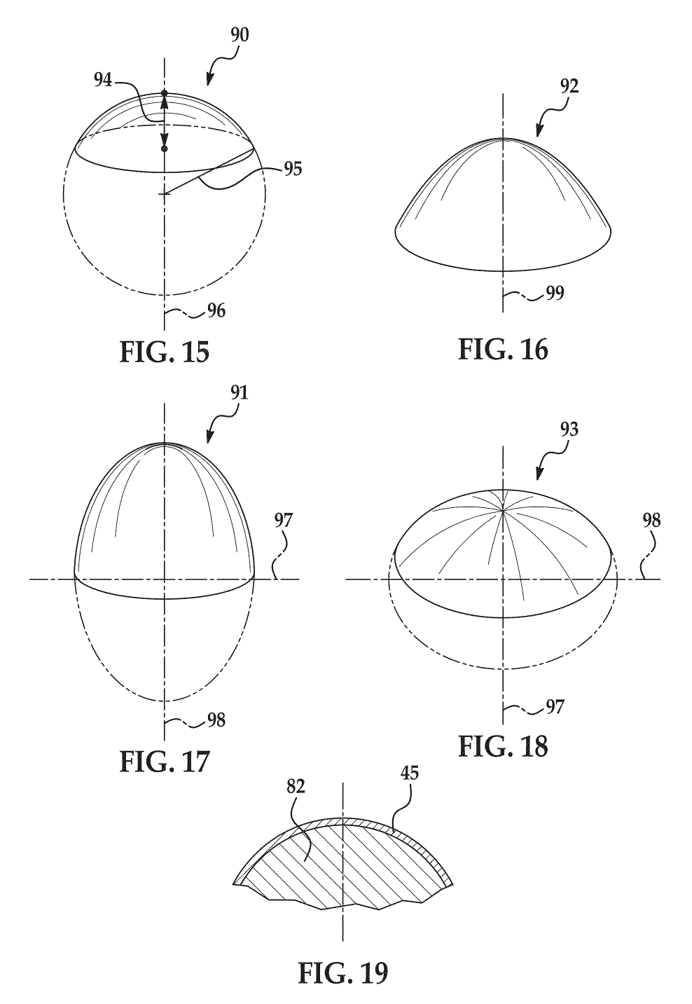

The blunt pellets of the present disclosure may be made in a variety of shapes. As disclosed herein the shape of the blunt pellet affects the nanocrystallization. Examples of the present disclosure may have blunt pellets including the shapes depicted in FIGS. 15-18. FIG. 15 depicts an example of a blunt pellet having a spherical cap shape. As used herein, a spherical cap shape means a solid having a surface defined by a spherical cap. A spherical cap is a portion of a sphere cut off by a plane. If the plane passes through the center of the sphere, so that the height of the cap is equal to the radius of the sphere, the spherical cap is called a hemisphere. It is to be understood that a spherical cap shape may include more than half of the sphere.

FIG. 16 depicts an example of a blunt pellet having a parabolic shape 92. As used herein, a parabolic shape 92 means a solid having a surface defined by a paraboloid of revolution. A paraboloid of revolution is a surface obtained by revolving a parabola around its axis of symmetry 99. FIG. 17 depicts an example of a blunt pellet having an ellipsoidal shape 91. As used herein, an ellipsoidal shape 91 means a portion of a solid having a surface defined by an ellipsoid of revolution. An ellipsoid of revolution is a surface obtained by revolving an ellipse around an axis of symmetry. FIG. 17 depicts a portion of a prolate ellipsoid of revolution formed by rotating an ellipse about its major axis 98. FIG. 18 depicts a portion of an oblate ellipsoid of revolution formed by rotating an ellipse about its minor axis 97. The ellipsoidal shape 91 disclosed herein includes both prolate and oblate ellipsoids of revolution.

FIG. 19 is a schematic cross-sectional view of a blunt pellet 82 with a friction coefficient enhancing coating 45. In examples of the present disclosure, a coefficient of friction enhancing coating 45 may be deposited on the blunt pellet 82. The coefficient of friction enhancing coating 45 may be any coating that increases the coefficient of friction between the blunt pellet 82 and the workpiece 12. Examples of the coefficient of friction enhancing coating 45 include TiN, TiCN, TiAlN, CrN, DLC, and CrTiN. The thickness of the coating may range from about 2 μm to about 100 μm.

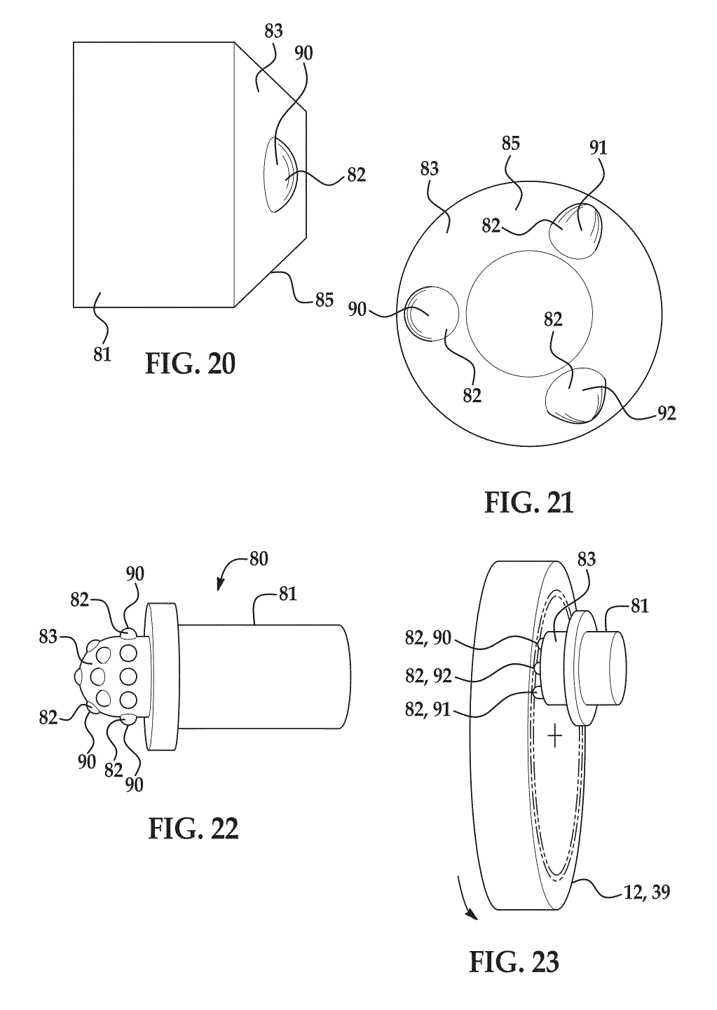

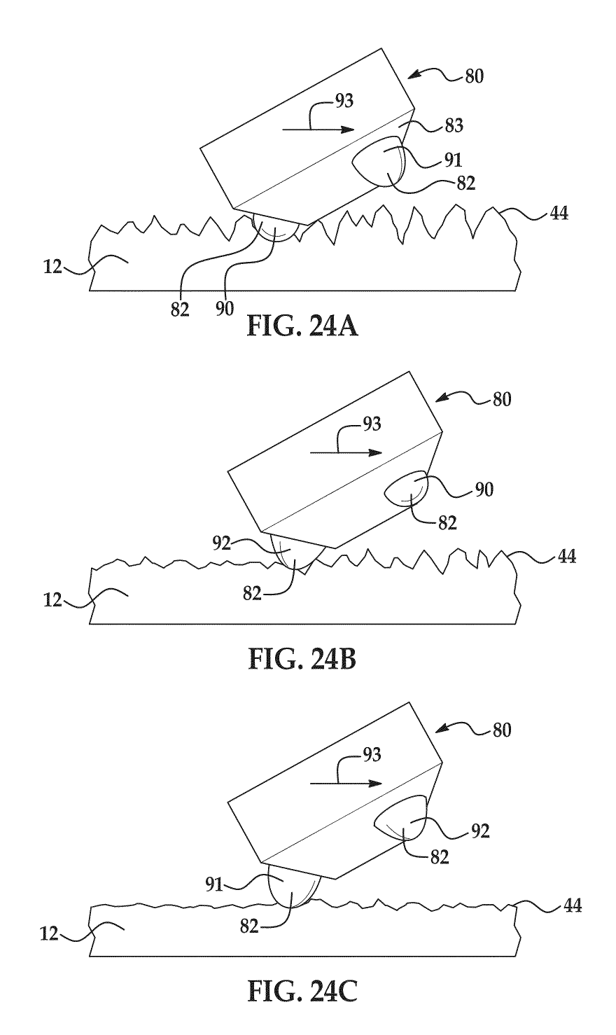

FIG. 20 is a semi-schematic side view of a tool in an example of the present disclosure. FIG. 21 is an end view of the tool depicted in FIG. 20. The tool base 81 is to removably attach to a machine, for example via a three jaw chuck (not shown). The example depicted in FIG. 20 and FIG. 21 has a frustoconical end 85 with 3 substantially equally spaced blunt pellets 82 projecting from the frustoconical end 85. In other examples, the end may have any shape that allows each blunt pellet 82 to be individually brought into contact with the finish surface 44 (see FIGS. 24A-24C). Each of the blunt pellets 82 in the example shown in FIG. 20 and FIG. 21 has a different shape. A blunt pellet 82 having a spherical cap shape 90 is visible in FIG. 20. In addition to the spherical cap shape 90 blunt pellet, FIG. 21 shows a parabolic shape 92 blunt pellet and an ellipsoidal shape 91 blunt pellet that were not visible from the point of view of FIG. 20.

FIG. 22 is a perspective view of a tool having a plurality of same shape blunt pellets 82 in an example of the present disclosure. The tool base 81 is to removably attach to a machine, for example via a three jaw chuck (not shown). A head portion 83 is attached to the tool base 81. The head portion 83 may be made from hard materials including iron-tungsten alloy, cast iron, silicon carbide, boron nitride, titanium nitride, hardened tool steel, tungsten carbide, or the like. The tool base 83 hardness may be lower than the hardness of the head portion 83. A plurality of the blunt pellets 82 extend outward from the head portion 83. In an example of the present disclosure, each of the blunt pellets may have a same shape at the respective workpiece-contacting surface. The blunt pellets shown in FIG. 22 each have the same spherical cap shape. After a blunt pellet wears against the workpiece, the tool may be rotated and/or translated to apply a new blunt pellet to the workpiece. As such, the life of the tool may be extended and the machine may operate substantially continuously without interruption for tool replacement for a longer time period compared to a tool without the reserve blunt pellets.

FIG. 23 is a schematic perspective view showing an example of a workpiece and a tool 80 operating thereon. The workpiece 12 depicted in FIG. 23 represents a brake disc 39. The blunt pellets 82 are aligned so that three blunt pellets operate on the workpiece 12 in succession with a single pass over a portion of the workpiece 12. In FIG. 23, the spherical cap shape 90 blunt pellet operates on the workpiece followed by a parabolic shape 92 blunt pellet and next followed by an ellipsoidal shape 91 blunt pellet. As such, the parabolic shape 92 blunt pellet follows the spherical cap shape 90 blunt pellet in the same process pass. Similarly, the ellipsoidal shape 91 blunt pellet follows the parabolic shape 92 blunt pellet in the same process pass.

FIGS. 24A-24C together depict the example of a method of using the tool shown in FIGS. 20 and 21 by operating on a workpiece 12 in 3 successive passes to nanocrystallize the workpiece 12 surface as disclosed herein. In FIGS. 24A-24C, the workpiece 12 has a machined, finish surface 44. In FIGS. 24A-24C, the surface roughness, and the change in surface roughness are greatly exaggerated to show that each pass has an effect on the nanocrystallization of the finish surface 44. The relative motion of the tool 80 with respect to the workpiece 12 is indicated by the arrow at reference numeral 93. It is to be understood that the tool 80 may be moved relative to a stationary workpiece 12; the workpiece 12 may be moved relative to a stationary tool 80; or both the workpiece 12 and tool 80 may be moved to achieve relative motion. In FIGS. 24A-24C, the progressive nanocrystallization with each pass of the tool 80 is shown, for illustration purposes, as an exaggerated change in the roughness of the finish surface 44. FIG. 24A depicts deforming a machined, finish surface of a cast iron workpiece by rubbing the machined, finish surface against one of the differently shaped blunt pellets (e.g. spherical cap shape 90) of the tool in the first pass, thereby forming a nanocrystallized microstructure having a first surface roughness.

The blunt pellets 82 reorganize the crystal structure of the finish surface 44 substantially without removing material therefrom. Each of the differently shaped blunt pellets 82 transform the finish surface 44 by forming a nanocrystallized microstructure having different size of grain or sub-grain. It is to be understood that the deformation of the finish surface 44 due to operation of the blunt tool 80 on the workpiece 12 may not be visible to the naked eye. However, a change in the reflective properties of the finish surface 44 may be observable to the naked eye.

In the example depicted in FIG. 24A the blunt pellet 82 has a spherical cap shape 90 operating on the finish surface 44.

FIG. 24B depicts an example in which the tool 80 has been rotated to place the blunt pellet 82 with a parabolic shape 92 into contact with the finish surface 44. FIG. 24B depicts altering, in a second pass, the first surface roughness to a second surface roughness by rubbing the nanocrystallized microstructure against a second of the differently shaped blunt pellets (e.g. parabolic shape 92) of the tool 80.

FIG. 24C depicts an example in which the tool 80 has been further rotated to place the blunt pellet 82 with an ellipsoidal shape 91 into contact with the finish surface 44. FIG. 24C depicts, in a third pass, altering the second surface roughness to a third surface roughness by rubbing the nanocrystallized microstructure against a third of the differently shaped blunt pellets (e.g. ellipsoidal shape 91) of the tool 80.

The present disclosure further includes a method for measuring a nanocrystallization effect. The method includes performing a surface rubbing process on a workpiece using a tool head under a set of controlled conditions. The surface rubbing process is to be performed using actual hardware; the rubbing process is not virtualized for this step in the process. As such, the surface rubbing process at this step is referred to herein as the “actual” surface rubbing process. The actual surface rubbing process is performed by applying a blunt pellet 82 to nanocrystallize at least a portion of the finish surface of the workpiece. After the actual surface rubbing process has been performed on the workpiece, the method includes measuring and mapping a surface distribution of grain size or sub-grain size on the workpiece. The map may be a three dimensional map with contour surfaces depicting uniform grain size or sub-grain size. In another example, the map may be a two dimensional map with contour lines depicting uniform grain or sub-grain size.

The method also includes, using Finite Element Analysis, building a numerical model to simulate a surface rubbing process, the numerical model including a workpiece and a tool head. The numerical model is to be capable of simulating at least the set of controlled conditions under which the actual surface rubbing process was performed. The controlled conditions may include the shape and material properties, of the blunt pellet 82, and the workpiece 12. Examples of the material properties of the blunt pellet 82 and the workpiece 12 include the elastic modulus, strength, thermal conductivity, etc. The simulation may include a friction coefficient between the blunt pellet 82 and the workpiece 12. The force applied by the tool head on the workpiece may be another condition included in the simulation. The method further includes, using a computer-aided engineering program on a computer 14 (see FIG. 25), running a simulation of the actual surface rubbing process including the numerical model under the controlled conditions to map equivalent plastic strain over the surface under the tool head. The equivalent plastic strain is the summation of d ε̅^̅{̅p̅}̅.

$$\begin{matrix}d \overline{{ɛ}^{p}} = \sqrt{\frac{2}{3} d {ɛ}_{ij}^{p} : d {ɛ}_{ij}^{p}} & Equation ( 1 ) \\ d \overline{{ɛ}^{p}} = \sqrt{\begin{matrix}\frac{2}{9} [ {( d {ɛ}_{11}^{p} - d {ɛ}_{22}^{p} )}^{2} + {( d {ɛ}_{11}^{p} - d {ɛ}_{33}^{p} )}^{2} + {( d {ɛ}_{22}^{p} - d {ɛ}_{33}^{p} )}^{2} ] + \\ 6 ( d {ɛ}_{12}^{p} + d {ɛ}_{13}^{p} + d {ɛ}_{23}^{p} )\end{matrix}} & Equation ( 2 )\end{matrix}$$

dε₁₁^{p} is an incremental plastic strain tensor.

The method of the present disclosure further includes correlating the equivalent plastic strain that is calculated in the simulation with grain or sub-grain size that is measured in the workpiece after the actual surface rubbing process. The correlation may be produced by comparing the map of equivalent plastic strain produced by the simulation with the map of grain or sub-grain size produced from the actual surface rubbing process. Generally, a higher equivalent plastic strain will correspond to smaller grain or sub-grain size. As such, the simulation may thereafter be used with the correlation to predict the grain or subgrain size for conditions other than the conditions of the actual rubbing process. By introducing the correlation into the numerical model, another numerical model may be created for predicting a grain or sub-grain size for a set of conditions.

Referring now to FIG. 25, examples of the computer 14 each include a combination of hardware and programming to perform examples of the methods for measuring a nanocrystallization effect disclosed herein. As used herein, hardware means processors (e.g., processor 16), servers, and other computer hardware systems. The processor 16 is capable of executing programming for performing steps of the methods for measuring a nanocrystallization effect disclosed herein. The computing system 15 is operatively connected to an input device 22, which may be a keyboard or a keypad, mouse, touchscreen, etc. which enables a user to input information into the computing system 15.

As used herein, programming means computer readable instructions 18 embodied on a non-transitory, tangible computer readable medium 19 that, when executed, carry out a specific function. Examples of the instructions 18 disclosed herein may be realized in any non-transitory, tangible computer readable media 19 for use by or in connection with an instruction execution system (e.g., computing system 15), such as a computer/processor based system, or another system that can obtain the logic from computer readable media 19 and execute the instructions 18 contained therein.

The non-transitory, tangible computer readable media 19 may be any media that is capable of containing, storing, or maintaining programs and data for use by or in connection with the computing system 15. It is to be understood that the media 19 may be integrated in the same device as the processor 16, or it may be separate from, but accessible to the respective computing system 15 and processor 16. Examples of computer readable media 19 may include any one of many physical media such as, for example, electronic, magnetic, optical, electromagnetic, or semiconductor media. More specific examples of suitable computer readable media 19 include a portable magnetic computer diskette such as floppy diskettes or hard drives, a random access memory (RAM), a read-only memory (ROM), an erasable programmable read-only memory (EPROM), or a portable CD, DVD, or flash drive.

Still further, the computer readable instructions 18 may be part of an installation package that can be executed by the processor 16 to implement at least some steps of the methods for measuring a nanocrystallization effect disclosed herein. In these instances, the medium 19 may be the previously mentioned portable medium, such as a compact disc (CD), a digital video disc (DVD), or a flash drive; or the medium 19 may be a memory maintained by a server from which the installation package can be downloaded and installed on the computing system 15. In another example, the computer readable instructions 18 may be part of an application or applications already installed on the computing system 15. In this other example, the medium 19 may include integrated memory, such as the previously mentioned hard drive.

Examples of the method of the present disclosure may reduce FNC cycle time by a factor of about 5 to 10 (e.g., reduced from about 5 to 6 hours to about 1 to 2 hours at 570° C.). Alternately, examples may enable low temperature FNC (reduced from 570° C. to about 400° C.-450° C.) to reduce part distortion. Examples of the present disclosure further produce workpieces with improved wear/fatigue resistance and corrosion resistance. Increased productivity is achievable compared to other surface nanocrystallization processes. For example, nanocrystallization by shot peening may require about 36 seconds per square centimeter. In sharp contrast, examples of the method disclosed herein may take about 2 seconds per square centimeter.

Numerical data have been presented herein in a range format. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature from about 550° C. to about 570° C. should be interpreted to include not only the explicitly recited limits of about 550° C. to about 570° C., but also to include individual amounts such as 552° C., 569° C., etc., and sub-ranges such as from about 555° C. to about 560° C., etc. Furthermore, when “about” is utilized to describe a value, this is meant to encompass minor variations (up to +/−10%) from the stated value.

Additionally, reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

1. A tool for enhancing surface nanocrystallization, the tool comprising:
a tool base to removably attach to a machine;
a head portion attached to the tool base; and
a plurality of blunt pellets i) each having a different shape at a respective workpiece-contacting surface to generate a different pressure distribution and depth of indentation during surface nanocrystallization and extending outward from the head portion, or ii) each having a same shape at the respective workpiece-contacting surface and extending outward from the head portion.

2. The tool as defined in claim 1 wherein the different shapes at the respective workpiece-contacting surface include a spherical shape, a parabolic shape, and an ellipsoidal shape.

3. The tool as defined in claim 2 wherein the plurality of blunt pellets are aligned such that at least one of the plurality of blunt pellets follows at least one other of the plurality of blunt pellets in a same process pass.

4. The tool as defined in claim 1 wherein the head portion is spherical, and wherein the same shape is selected from the group consisting of a spherical shape, a parabolic shape, and an ellipsoidal shape.

5. The tool as defined in claim 1, further comprising a coating deposited at least on the workpiece-contacting surface of each of the plurality of blunt pellets, the coating selected from the group consisting of diamond like coating (DLC), TiN, TiCN, TiAlN, CrN, CrTiN, and combinations thereof.

6. The tool as defined in claim 1 wherein each of the plurality of blunt pellets is formed from a material chosen from iron-tungsten alloys, cast iron, silicon carbide, boron nitride, titanium nitride, diamond, hardened tool steel, and tungsten carbide.

7. A method for using the tool as defined in claim 1, the method comprising deforming a machined, finish surface of a cast iron workpiece by rubbing respective portions of the machined, finish surface against the differently shaped blunt pellets of the tool during a single pass, thereby forming a nanocrystallized microstructure having a different size of grain or sub-grain at the respective portions of the machined, finish surface.

8. A method for using the tool as defined in claim 1, the method comprising:
in a first pass, deforming a machined, finish surface of a cast iron workpiece by rubbing the machined, finish surface against one of the differently shaped blunt pellets of the tool, thereby forming a nanocrystallized microstructure having a first surface roughness;
in a second pass, altering the first surface roughness to a second surface roughness by rubbing the nanocrystallized microstructure against a second of the differently shaped blunt pellets of the tool; and
in a third pass, altering the second surface roughness to a third surface roughness by rubbing the nanocrystallized microstructure against a third of the differently shaped blunt pellets of the tool.

9. A method for using the tool as defined in claim 1, the method comprising:
deforming a machined, finish surface of a cast iron workpiece by rubbing the machined, finish surface against at least two of the same shaped blunt pellets or differently shaped blunt pellets of the tool, thereby forming a nanocrystallized microstructure; and
when the at least two of the same shaped or differently shaped blunt pellets exhibit wear, rotating the tool and deforming an other machined, finish surface of an other cast iron workpiece by rubbing the other machined, finish surface against at least two other of the same shaped or differently shaped blunt pellets of the tool, thereby forming an other nanocrystallized microstructure.

10. A tool for enhancing nanocrystallization of a finished surface of a cast iron workpiece, the tool comprising:
a tool base having a head portion;
a blunt pellet attached to the head portion; and
a coefficient of friction enhancing coating deposited on the blunt pellet.

11. The tool as defined in claim 10 wherein the coefficient of friction enhancing coating is selected from the group consisting of TiN, TiCN, TiAlN, CrN, DLC, and CrTiN.

12. The tool as defined in claim 10 wherein a thickness of the coating ranges from about 2 μm to about 100 μm.

13. A method for measuring a nanocrystallization effect, the method comprising:
performing a surface rubbing process on a workpiece using a tool head under a set of controlled conditions;
measuring and mapping a surface distribution of grain size or sub-grain size on the workpiece after the surface rubbing process has been performed thereon;
using Finite Element Analysis, building a numerical model to simulate a surface rubbing process, the numerical model including a workpiece and a tool head;
using a computer-aided engineering program, running a simulation of the surface rubbing process including the numerical model under the controlled conditions to map equivalent plastic strain over the surface under the tool head wherein:
the equivalent plastic strain is the summation of d ε̅^̅{̅p̅}̅;
$$\begin{matrix}d \overline{{ɛ}^{p}} = \sqrt{\frac{2}{3} d {ɛ}_{ij}^{p} : d {ɛ}_{ij}^{p}} ; \\ d \overline{{ɛ}^{p}} = \sqrt{\begin{matrix}\frac{2}{9} [ {( d {ɛ}_{11}^{p} - d {ɛ}_{22}^{p} )}^{2} + {( d {ɛ}_{11}^{p} - d {ɛ}_{33}^{p} )}^{2} + {( d {ɛ}_{22}^{p} - d {ɛ}_{33}^{p} )}^{2} ] + \\ 6 ( d {ɛ}_{12}^{p} + d {ɛ}_{13}^{p} + d {ɛ}_{23}^{p} )\end{matrix}} ;\end{matrix}$$
and
dε₁₁^{p} is an incremental plastic strain tensor; and
correlating the equivalent plastic strain with grain or sub-grain size in the workpiece after the surface rubbing process such that higher equivalent plastic strain corresponds with smaller grain or sub-grain size.

14. The method as defined in claim 13, further comprising:
introducing the correlation into the numerical model to create an other numerical model for predicting a grain or sub-grain size for a set of conditions.
